(19) United States
(12) Patent Application Publication
(10) Pub. No.: US 2003/0085392 A1
(43) Pub. Date: May 8, 2003

(54) Hand operated cable dragging machine

(76) Inventor: Ching-Fong Hsieh, Feng-Yuan City (TW)

Correspondence Address: Ching-Fong Hsieh, P.O. Box 697, Feng-Yuan City, 420, TW

(21) Appl. No.: 09/985,990

(22) Filed: Nov. 7, 2001

(51) Int. Cl. B66D 1/14

(52) U.S. Cl. 254/369; 254/374

(57) ABSTRACT

A hand operated cable dragging machine includes a frame having a hook and a check pawl on one end, a tongue and a guide tube on the other end a cover with a crest on bottom and a capstan, a ratchet and a Y-shaped handle coaxially and rotatably secured in the middle portion of the frame. A check pawl in the frame to prevent the ratchet from turning backward. A pawl member in the Y-shaped handle to operated the ratchet and the capstan. An adjustable device above the pawl member for controlling the engagement condition of the pawl member with the ratchet. It is characterized that this hand operated cable dragging machine can be able to serve any sized cable and the length of the cable is not limitative so as capable of dragging the heavy object at along distance.

### BACKGROUND OF THE INVENTION

The present invention relates to dragging machines and more particularly to a hand operated cable dragging machine which has a capstan and an adjustable button to enable the machine to suit to any sized cable without length limitation.

To move or to hang up a heavy object, the cable dragging machine is indispensable in a factory, a garage or even in a family. Some of the car owners have miniature cable dragging machine prepared to offset the shortage of hands when moving their cars.

Typical hand operated cable dragging machine (as shown in FIG. 1) comprises generally a cable or rope 10 having one end wound on a roller between a pair of ratchets 11 which are operated by a pair of arms 16 of a Y-shaped handle 21 and controlled by a pair pawls 13, a hook 12 on the free end of the cable 10 for binding the cable 10 to a working object, and an adjustable device 14 to control the pawls 13. The adjustable device 14 has a spring 15 having an upper end secured to a retaining pin 17 and a lower end 22 hooked to an arcuate thru hole 19 of a roughly U-shaped plate 18 and a sleeve 20 wrapped on the spring 15. This type of cable dragging machine is very convenient to use. However, the length of the cable 10 is limitative because the roller can not contain a long cable. Therefore, it couldn't move a long distance object.

### SUMMARY OF THE PRESENT INVENTION

The present invention has a main object to provide a hand operated cable dragging machine which can be able to drag endless cable of different size or made of different material.

Another object of the present invention is to provide a hand operated cable dragging machine in which an improved adjustable device is provided to have the cable dragging machine to be operated more convenient and more practical.

The present invention will become more fully understood by reference to the following detailed description thereof when read in conjunction with the attached drawings.

### BRIEF DESCRIPTION OF THE DRAWINGS

FIG. 1 is a perspective view to show a hand operated cable dragging machine according to a prior art,

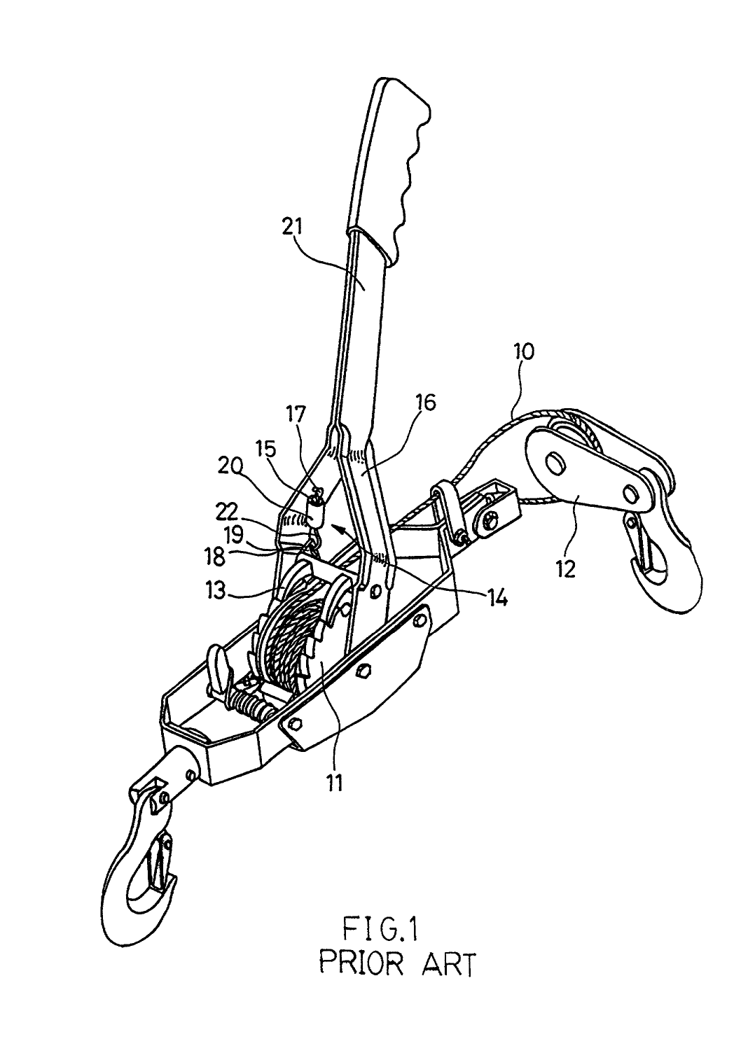

FIG. 2 is an exploded perspective view to show a hand operated cable dragging machine of the preferred embodiment according to the present invention,

FIG. 3 is a perspective view to show an assembly of FIG. 2,

FIG. 4 is a sectional view to show the relationship between a capstan and a tongue, and

FIG. 5 is a flat view to show an adjustable device being moved upwards or downwards to change the engagement condition of a pawl member to engage on a ratchet according to the present invention.

### DETAILED DESCRIPTION OF THE PREFERRED EMBODIMENT

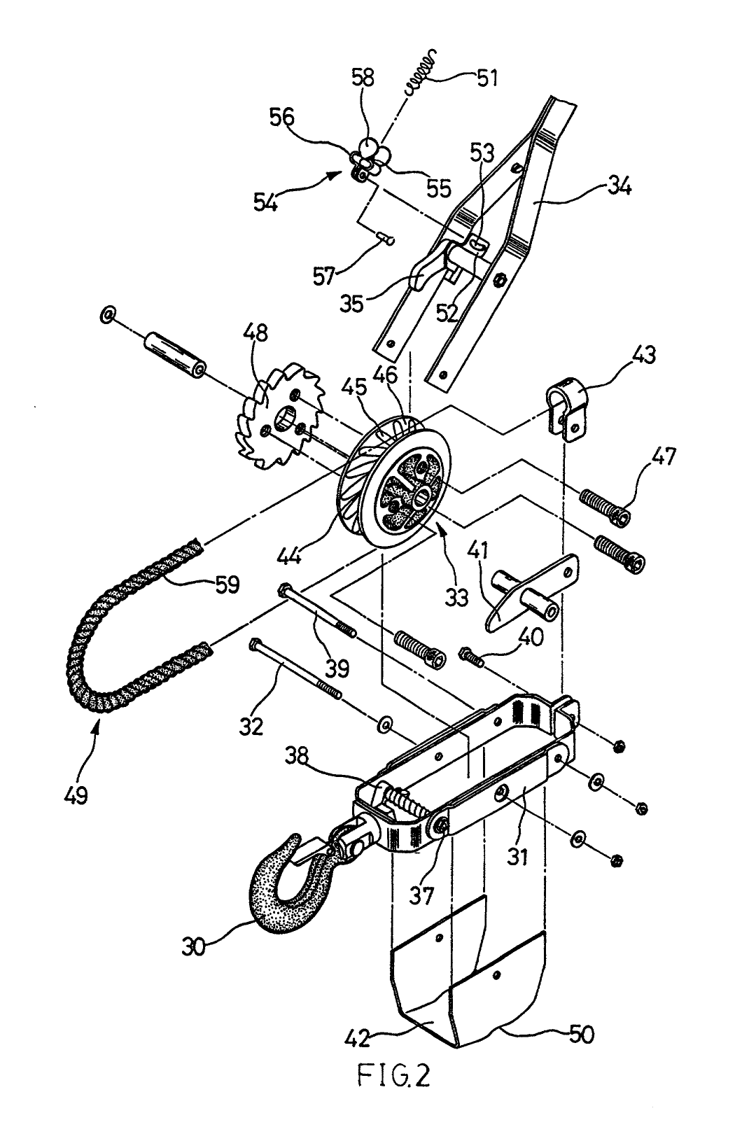

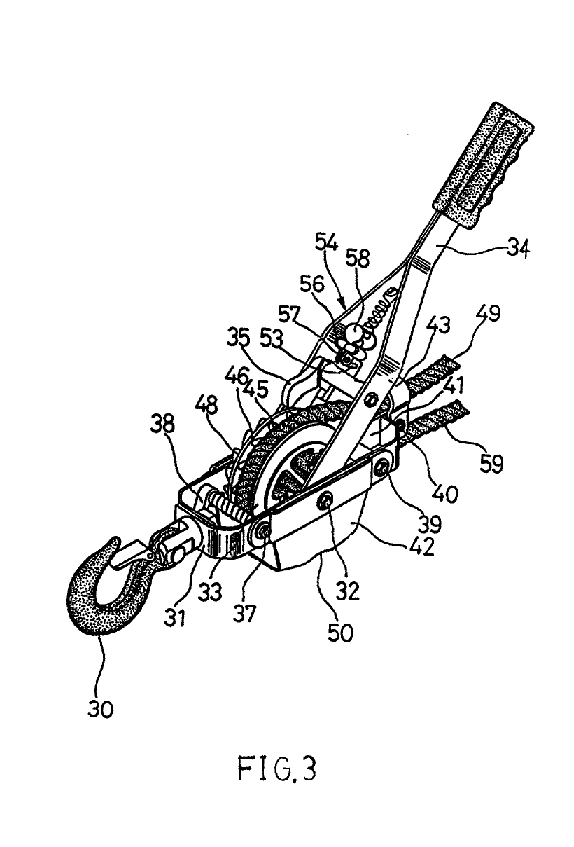

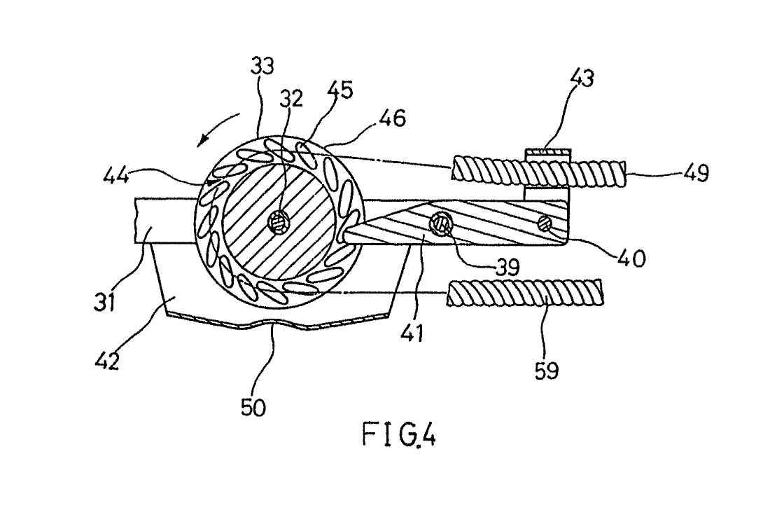

With reference to FIGS. 2, 3 and 5 of the drawings, the hand operated cable dragging machine of the present invention comprises generally a frame 31, a hook 30 pivotally connected to one end of the frame 31, a capstan 33, a ratchet 48 and a pair of arms of a Y-shaped handle 34 coaxially and rotatably secured to the middle portion of the frame 31 by bolt 32 and nut with a pair washers and a tubular member engaged therebetween, a plurality of bolts 47 securing the capstan 33 and the ratchet 48 together, a tongue member 41 together with a guide tube 43 secured to the other end of the frame 31 by bolt 40 and nut, the tongue 41 having a tubular portion secured to the frame 31 by bolt 39 and nut with awasher engaged therebetween, a check pawl 38 secured to an inner wall of the frame 31 by a screw 37 and positioned near the hook 30 for preventing the ratchet 48 from turning backward. The capstan 33 has a V-shaped annular groove 44 in outer periphery and a plurality of volute cycloid slots 45 spacedly formed in the opposing walls of the V-shaped annular groove 44 to define a plurality of ribs 46 therebetween. The inner end of the tongue 41 engages with the V-shaped annular groove 44 for preventing the cable 49 from captured by the slots 45 without to set apart (as shown in FIG. 4). A cover 42 of U-shaped section secured to the bottom of the frame 31 having a crest 50 at a middle portion. The cable 49 is entered into the dragging machine through the guide tube 43 and wound around the capstan 33 then extended out of the cover 42 through the crest 50. A pawl member 35 integrated with a hollow cylinder rotatably secures between the arms of a Y-shaped handle 34 and has a rectangular plate 52 projected upward from an upper periphery of the cylinder. The rectangular plate 52 includes an arcuate slot 53 therein. The free end of the pawl member 35 engages with the teeth of the ratchet 48 (as shown in FIG. 3). An adjustable device 54 includes a roughly inverse U-shaped plate 56 having a pair of extensions extending downward and slidably secured to the arcuate slot 53 by rivet 57, an eye 55 on the top of the inverse U-shaped plate 56 and a pair of thumbpieces 58 spacedly projected upward from two ends of the inverse U-shaped plate 56. A spring 51 has a lower end secured to the eye 55 and an upper end to a protrusion on an inner side of one of the arms.

In operation, oscillate the handle 34, the pawl member 35 will actuate the ratchet 48 and the capstan 33 to rotate counterclockwise the cable 49 in the V-shaped annular groove 44 of the capstan 33 will be captured by the volute cycloid slots 45 and the ribs 46 because of the twist veins 59 and dragged in to move in the heavy object. The weight of the working object causes the twist veins 59 of the cable 49 more deeper in the volute cycloid slots 45 so that the tongue 41 is useful to stir up the cable 49 before the free end of the cable stretching out of the cover 42. Furthermore, the guide tube 43 and the crest 50 have their functions to limit the cable 49 in the V-shaped annular groove 44 of the capstan 33 without breakaway.

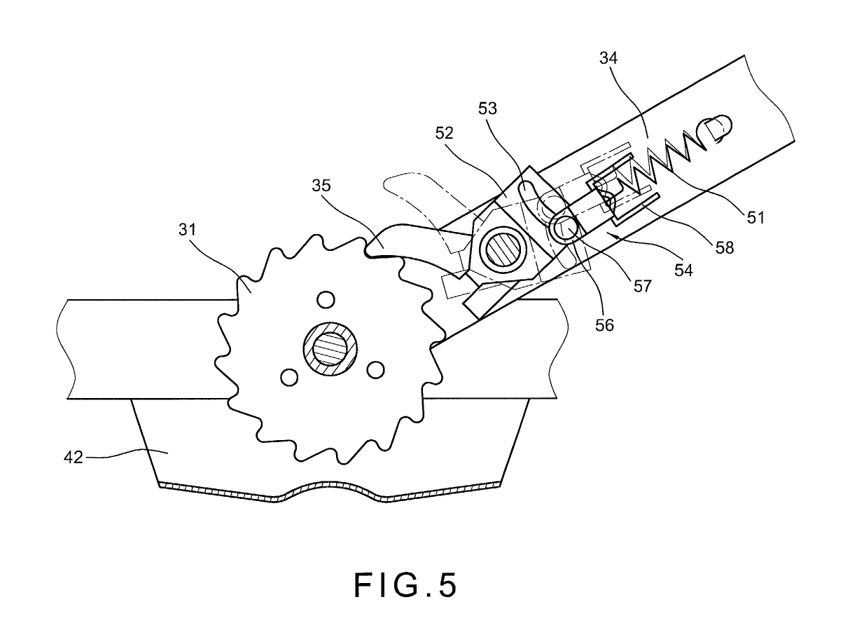

The adjustable device 54 is useful to change the engagement condition of the pawl member 35 with the ratchet 48 by applying the thumbpieces 58 to slide about the rivet 57 in the arcuate slot 53 in order to change the angle of the pawl member 35 (as shown in FIG. 5).

The specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A hand operated cable dragging machine comprising:
a frame, a hook pivotally connected to one end of the frame and positioned outside of the frame, a tongue together with a guide tube secured to other end of the frame by a first bolt and nut, said tongue having a tubular portion secured inside the frame by a second bolt and nut with a washer engaged therebetween, a capstan, together with a ratchet and a pair of arms of a Y-shaped handle rotatably and coaxially secured in the frame by a third bolt and nut with washers and a tube engaged therebetween and at a middle portion of the frame, a plurality of screws securing the capstan and the ratchet together, a check pawl secured on an inner wall of the frame by a screw and positioned near the hook for preventing the ratchet from turning backward, a cover covering bottom of the frame and having a crest at a middle portion thereof;
a pawl member engageable with teeth of the ratchet having a hollow cylinder rotatably secured in the arms of the Y-shaped handle therebetween and at a predetermined position, a rectangular plate projected upward from an upper periphery of the hollow cylinder including an arcuate slot therein;
an adjustable device above the pawl member having an inverse U-shaped plate including a pair of extensions extended downward and slidable secured by a rivet to the arcuate slot of the hollow cylinder member, an eye on a central top of the inverse U-shaped plate and a pair of thumbpieces spacedly projected upward from two ends of the inverse U-shaped plate;
a spring means having a lower end secured to the eye of the inverse U-shaped plate and an upper end secured to a protrusion on an inner surface of one of the arms;
a cable having one end wound on a working object and other end inserting into the dragging machine through the guide tube and winding around the capstan then stretching out of the dragging machine through the crest of the cover.

2. The cable dragging machine as recited in claim 1 wherein said capstan has a V-shaped annular groove in outer periphery an a plurality of volute cycloid slots spacedly formed in opposing walls of the V-shaped annular groove to defined a plurality of ribs therebeen.

3. The cable dragging machine as recited in claim 1 wherein said thumbpieces can be in different shapes and the space therebeen may be adjusted.
